(19) United States
(12) Patent Application Publication
(10) Pub. No.: US 2023/0062682 A1
(43) Pub. Date: Mar. 2, 2023

(54) MEC REACTOR SYSTEM FOR STRENGTHENING ANAEROBIC DIGESTION

(71) Applicants: Tongji University, Shanghai (CN); Shanghai Urban Pollution Control Engineering Research Center Co., Ltd., Shanghai (CN)

(72) Inventors: Xiaohu DAI, Shanghai (CN); Lei LI, Shanghai (CN); Yongdong CHEN, Shanghai (CN); Haoyu LIU, Shanghai (CN); Chen CAI, Shanghai (CN)

(21) Appl. No.: 17/576,006

(22) Filed: Jan. 14, 2022

(30) Foreign Application Priority Data
Aug. 26, 2021 (CN) 202110990012.3

(51) Int. Cl. C02F 3/00; C02F 11/04; C02F 11/00

(52) U.S. Cl. CPC C02F 3/005; C02F 11/04; C02F 11/006; C02F 2203/006; C02F 3/282

(57) ABSTRACT

An MEC reactor system for strengthening anaerobic digestion is provided. The MEC reactor system includes a reactor module; multiple biological anode plates and multiple biological cathode plates which are arranged in the reactor module; and an automatic control power supply. An anode and a cathode of the automatic control power supply are respectively connected with anode area wires and cathode area wires, the anode area wires are electrically connected with the biological anode plates, and the cathode area wires are electrically connected with the biological cathode plates. The biological anode plates and the biological cathode plates are subjected to biofilm culturing and acclimation in a biological anode plate acclimation area and a biological cathode plate acclimation area respectively; and in an anaerobic digestion reaction area, anaerobic digestion is strengthened based on the biological anode plates and the biological cathode plates which complete biofilm culturing acclimation.

### CROSS REFERENCE TO RELATED APPLICATION

This patent application claims the benefit and priority of Chinese Patent Application No. 202110990012.3 filed on Aug. 26, 2021, the disclosure of which is incorporated by reference herein in its entirety as part of the present application.

### TECHNICAL FIELD

The present disclosure relates to the technical fields of environmental protection and resource recovery, and particularly relates to an MEC reactor system for strengthening anaerobic digestion.

### BACKGROUND ART

In the field of sewage and organic waste treatment, synergetic interaction of pollution reduction and carbon reduction, resource and energy recovery enhancement are key links for achieving carbon emission reduction and even negative carbon emission. The anaerobic digestion technology is a biological treatment green technology widely applied to the treatment of sewage, sludge and various organic wastes, biomass resource energy can be recycled while pollutant harmless treatment is implemented, and generated biogas can be used as renewable energy to effectively replace fossil energy such as petroleum and the like. The technology is important technical support for supporting ecological civilization construction and social sustainable development.

The anaerobic digestion technology as a mature technology, when being applied to the treatment of organic waste, has a series of problems, such as long treatment period, low biogas production efficiency, and low proportion of methane in biogas. In order to further improve anaerobic digestion performance, researchers have made a number of different attempts, and the MEC (Microbial Electrolysis Cell) technology is one of the attempts. The coupling of MEC and anaerobic digestion is also called MEC-AD (Microbial Electrolysis Cell-Anaerobic Digestion) technology, and has a series of technical advantages, such as strengthening organic matter hydrolysis, and improving methane production efficiency. The Chinese patent publications No. CN103922554A entitled “a method for promoting anaerobic digestion of sludge through microbial electrical mediation” and No. CN109952275A entitled “a process and a system for wastewater treatment” and the like all adopted the MEC technology to strengthen anaerobic digestion based on the idea. However, most of existing MEC reactor systems focus on combination of the MEC reactor systems and anaerobic digestion as well as optimization of operation process such as pretreatment, electrode materials, voltage and system electron transfer, and the requirements for intelligent control, efficient starting and large-scale production of the MEC reactor systems are ignored during actual engineering application, and the requirements for actual processes are eliminated.

Therefore, in order to promote the development and application of the MEC reactor system in the field of anaerobic digestion, a novel intelligent, efficient and expanded MEC reactor system is urgently required.

### SUMMARY

The embodiments aim to overcome the defects in the prior art, and provides an MEC reactor system for strengthening anaerobic digestion so as to solve the technical problems of low intelligent level, low actual starting efficiency, difficulty in large-scale application and the like when an existing MEC reactor system is applied to anaerobic digestion.

The purpose of the present disclosure can be realized through the following technical scheme:

The present disclosure aims to protect an MEC reactor system for strengthening anaerobic digestion, which includes a reactor module, and multiple biological anode plates and multiple biological cathode plates which are arranged in the reactor module.

The MEC reactor system further includes an automatic control power supply, an anode and a cathode of the automatic control power supply are connected with anode area wires and cathode area wires respectively, the anode area wires are electrically connected with the biological anode plates, and the cathode area wires are electrically connected with the biological cathode plates.

The reactor module includes a biological anode plate acclimation area, a biological cathode plate acclimation area and an anaerobic digestion reaction area;

The biological anode plates and the biological cathode plates are subjected to biofilm culturing and acclimation in the biological anode plate acclimation area and the biological cathode plate acclimation area.

The biological anode plates and the biological cathode plates which complete biofilm culturing and acclimation, are placed in the anaerobic digestion reaction area, to strengthen the anaerobic digestion.

In some embodiments, the automatic control power supply may include a current sensor and a programmable direct-current power supply, and the current sensor may acquire an output current value of the programmable direct-current power supply in real time and may feed the current value back to the programmable direct-current power supply in real time.

In some embodiments, a number of the biological anode plates and a number of the biological cathode plates may be greater than or equal to two, and a ratio of the number of the biological anode plates to the number of the biological cathode plates may be (0.2 to 5):1. Through the design of the multiple biological anode plates and multiple biological cathode plates, the integrity and the operation efficiency of the MEC reactor system are improved, and the scale level of the MEC reactor system can be effectively improved. By changing the number ratio of the biological anode plates to the biological cathode plates, the system can be adapted to the anaerobic digestion process of organic wastes with different properties, different links of anaerobic digestion are strengthened in a targeted mode, and then efficient operation of the MEC reactor system is achieved.

In some embodiments, the biological anode plates and the biological cathode plates may be hollow annular plates.

The ratio of a ring width of each hollow annular plate to the outer diameter of the hollow annular plate may be (0.1 to 0.6):1, and the thickness of the hollow annular plate may be 1 to 10 cm. Through the design of the hollow annular plates and the selection of different ratios of the ring width to the outer diameter of the hollow annular plate, the internal space of the MEC reactor system is optimized, multi-layer laying can be achieved while reactor stirring is not affected, the effective working areas of the biological electrode plates are increased as much as possible, and the mass transfer reaction performance of the system is optimized.

In some embodiments, when the biological anode plates are subjected to biofilm culturing acclimation in the biological anode plate acclimation area, an anode potential may be 0.1 to 1.0 V, and a first acclimation time may be 10 to 30 d.

The biological cathode plates are subjected to biofilm culturing and acclimation in the biological cathode plate acclimation area, a cathode potential is −0.1 to −0.8 V, and a second acclimation time is 15 to 40 days (d). The biological anode plate acclimation area and the biological cathode plate acclimation area are creatively arranged, special biofilm culturing acclimation operation is carried out according to the growth conditions and scales of anode biofilms and cathode biofilms in the anaerobic digestion process, and the substrate, potential and acclimation time of the acclimation area can be adjusted according to the requirements of anaerobic digestion. Therefore, the anode biofilms and the cathode biofilms with high reaction activity are rapidly grown, the efficient biological anode plates and the efficient biological cathode plates are formed, and the starting efficiency and the operation effect of the MEC reactor for anaerobic digestion are improved.

In some embodiments, each anode area wire and each cathode area wire may be respectively provided with first multiple branch wires and second multiple branch wires, which are anode area branch wires and cathode area branch wires respectively.

The biological anode plates may be connected with the anode area branch wires, each of the biological anode plates may be connected with a corresponding one of the anode area branch wires, or symmetrically connected with corresponding two anode area branch wires, or connected with corresponding four anode area branch wires which are distributed uniformly around the biological anode plates.

The biological cathode plates may be connected with the cathode area branch wires, each biological cathode plate may be connected with a corresponding one of the cathode area branch wires, or symmetrically connected with corresponding two cathode area branch wires, or connected with corresponding four cathode area branch wires which are distributed uniformly around the biological cathode plates.

Through the design of the anode area wires and the cathode area wires, the MEC reactor can form good current paths, the number of the wires is reduced through a multi-access-point mode to avoid line redundancy and complexity, and a system circuit is simplified; and through the design of the connection mode between the electrode plates and the wires, connection can be carried out in various modes, the distribution uniformity of potentials on the electrode plates is guaranteed to a greater extent, and the performance of the reactor is optimized.

In some embodiments, in an operation process of the MEC reactor system for strengthening anaerobic digestion, the biological anode plates and the biological cathode plates which have been subjected to the biofilm culturing and acclimation, may be sequentially arranged in an anaerobic digestion reaction area in the vertical direction according to one of various number ratios, then are correspondingly connected with the anode area wires and the cathode area wires, and are connected with the automatic control power supply. Therefore, the system is completely arranged. By adopting the mode that the multiple biological anode plates and multiple biological cathode plates are subjected to biofilm culturing and acclimation are combined with the anaerobic digestion reaction area, the starting efficiency and the scale level of the MEC reactor system can be effectively improved, and the stable biofilm culturing electrode plates can adapt to the anaerobic digestion process of complex organic wastes more quickly, and the system has better electrochemical performance and anaerobic digestion performance.

In some embodiments, in an operation process of the MEC reactor system for strengthening anaerobic digestion, after feeding the MEC reactor system, the automatic control power supply may be turned on, the current sensor monitors a current change of the system, and when the current of the system is stable and is in a range of 1 to 200 mA, the system may be regarded as stable operation. The current sensor is configured for monitoring the current of the system in real time and feeding the current back to the programmable direct-current power supply, and the voltage output by the direct-current power supply is set according to the input current, so that the micro-voltage of the MEC reactor system is intelligently and accurately optimized in real time, and the high-efficiency and low-consumption operation of the MEC reactor system is achieved.

In some embodiments, the system may be fed in one mode of batch feeding, semi-continuous feeding and continuous feeding. The MEC reactor system has wide adaptability, and can effectively complete treatment and recycling processes of organic matters under different feeding modes, different feeding substrates and different feeding concentrations.

In some embodiments, a temperature of the anaerobic digestion reaction area may be 25° C. to 65° C., a stirring speed may be 60 to 150 rpm, and a residence time may be 5 to 30 d. According to the technical scheme, the MEC reactor system can be effectively combined with low-temperature, medium-temperature and high-temperature anaerobic digestion processes, and can bear higher organic load in the same retention time.

In some embodiments, in the automatic control power supply, an induction range of the current sensor is 1 mA to 1 A, and a voltage range of the programmable direct-current power supply is 0 to 5 V. By adopting the mode that the high-sensitivity current sensor is combined with the programmable direct-current power supply, current values collected by the current sensor serve as input values of the programmable direct-current power supply, an output voltage value of direct-current voltage is changed in real time according to a programming algorithm, and therefore it is guaranteed that the current value of the system does not change along with fluctuation of the anaerobic digestion process, stable operation of the MEC reactor is kept, and accurate regulation and control of the MEC reactor system are realized.

Compared with the prior art, the embodiments have the following advantages:

Firstly, the system is intelligent. The current sensor is configured for monitoring the current of the system in real time and feeding the current back to the programmable direct-current power supply, and the voltage output by the direct-current power supply is set by an internal MCU in the programmable direct-current power supply according to the input current, so that the micro-voltage of the MEC reactor system is intelligently and accurately optimized in real time, and the high-efficiency and low-consumption operation of the MEC reactor system is achieved.

Secondly, the system is efficient. The biological anode plate acclimation area and the biological cathode plate acclimation area are creatively arranged, special biofilm culturing and acclimation operation is carried out according to the growth conditions and scales of anode biofilms and cathode biofilms in the anaerobic digestion process, and the substrate, potential and acclimation time of the acclimation area can be adjusted according to the requirements of anaerobic digestion. Therefore, the anode biofilms and the cathode biofilms with high reaction activity are rapidly grown, the efficient biological anode plates and the efficient biological cathode plates are formed, and the starting efficiency and the operation effect of the MEC reactor for anaerobic digestion are improved.

Thirdly, the system is expanded. Through the design of the hollow annular plates and the selection of different ratios of the ring width to the outer diameter of the hollow annular plate and the design of the multiple biological anode plates and multiple biological cathode plates, the internal space of the MEC reactor system is optimized, multi-layer laying can be achieved while reactor stirring is not affected, the effective working areas of the biological electrode plates are increased as much as possible, and the mass transfer reaction performance of the system is optimized; and by changing the ratio of the number of the biological anode plates to the number of the biological cathode plates, the system can be adapted to the anaerobic digestion process of organic wastes with different properties, different links of anaerobic digestion are strengthened in a targeted mode, and then efficient operation of the MEC reactor system is achieved.

### BRIEF DESCRIPTION OF THE DRAWINGS

FIG. 1 is a schematic diagram of a composition and operation state of an MEC reactor system according to the present disclosure.

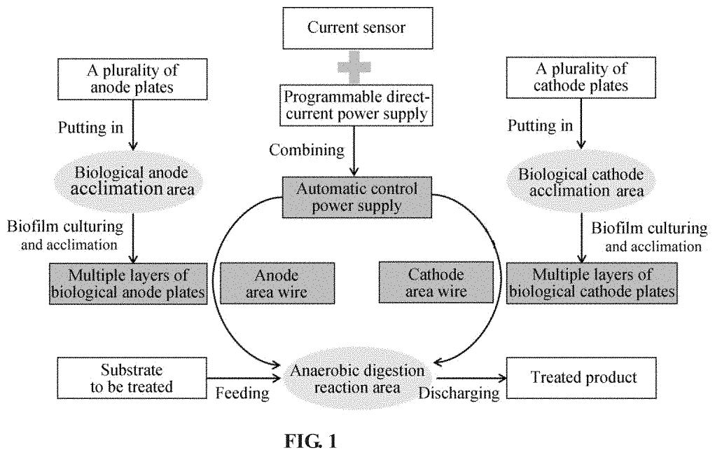

FIG. 2 is a schematic diagram of an MEC reactor device adopting the configuration of the system.

FIG. 3 is a schematic diagram showing a connecting of biological anode plates, biological cathode plates and wires in the MEC reactor adopting the configuration of the system.

Reference numerals: 0 reactor shell; 1 automatic control power supply; 2 biological anode plate; and 3 biological cathode plate.

### DETAILED DESCRIPTION OF THE EMBODIMENTS

The MEC reactor system for strengthening anaerobic digestion in the technical scheme, through automatic control of a power supply, biofilm culturing and acclimation of biological anode plates and biological cathode plates and design and arrangement of multiple layers of biological anode plates and biological cathode plates, the requirements for intelligence, high efficiency and expansion of the MEC reactor are met, the anaerobic digestion strengthening capacity and efficiency of the MEC reactor can be effectively improved, and the system can be used for improving the anaerobic digestion performance of high-concentration and complex organic wastes, and has good engineering application prospects.

An anode and a cathode of an automatic control power supply 1 in the technical scheme are connected with anode area wires and cathode area wires respectively, the anode area wires are electrically connected with the biological anode plates 2, and the cathode area wires are electrically connected with the biological cathode plates 3.

The reactor module includes a biological anode plate acclimation area, a biological cathode plate acclimation area and an anaerobic digestion reaction area. The biological anode plates and the biological cathode plates are subjected to biofilm culturing and acclimation in the biological anode plate acclimation area and the biological cathode plate acclimation area respectively; and the anaerobic digestion reaction area, anaerobic digestion is strengthened based on the biological anode plates and the biological cathode plates which complete biofilm culturing and acclimation.

The automatic control power supply 1 includes a current sensor and a programmable direct-current power supply, and the current sensor acquires an output current value of the programmable direct-current power supply in real time and feeds the current value back to the programmable direct-current power supply in real time.

The number of the biological anode plates 2 and the number of the biological cathode plates 3 are greater than or equal to two, and the ratio of the number of the biological anode plates 3 to the number of the biological cathode plates 3 is (0.2 to 5):1. The biological anode plates 2 and the biological cathode plates 3 are hollow annular plates; and ratio of a ring width of each hollow annular plate to the outer diameter of the hollow annular plate is (0.1 to 0.6):1, and a ring thickness of the hollow annular plate is 1 to 10 cm.

When the biological anode plates 2 are subjected to biofilm culturing and acclimation in the biological anode plate acclimation area, an anode potential is 0.1 to 1.0 V, and a first acclimation time is 10 to 30 d. The biological cathode plates 3 are subjected to biofilm culturing and acclimation in the biological cathode plate acclimation area, a cathode potential is −0.1 to −0.8 V, and a second acclimation time is 15 to 40 d.

Each anode area wire and each cathode area wire are respectively provided with first multiple branch wires and second multiple branch wires which are anode area branch wires and cathode area branch wires; the biological anode plates 2 are connected with the anode area branch wires respectively, each biological anode plate 2 is connected with one anode area branch wire or symmetrically connected with two anode area branch wires or connected with four anode area branch wires which are uniformly distributed around the biological anode plates 2. The biological cathode plates 3 are connected with the cathode area branch wires respectively, each biological cathode plate 3 is connected with one cathode area branch wire, or symmetrically connected with two cathode area branch wires, or connected with four cathode area branch wires which are uniformly distributed around the biological cathode plates 3.

The following describes the present disclosure in conjunction with attached figures and detailed description.

### Embodiment I

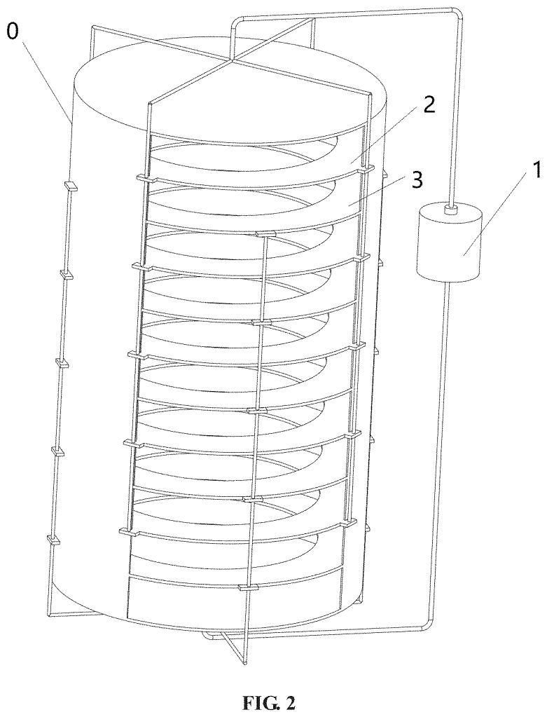

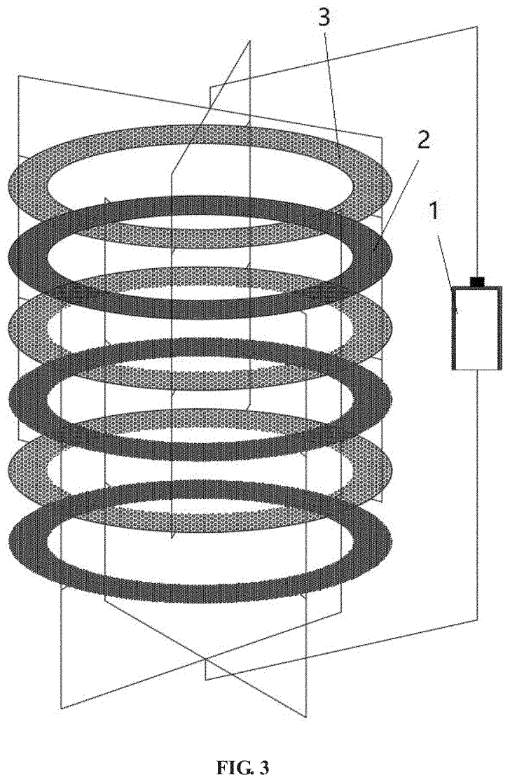

In the embodiment, as shown in FIG. 2, a main body of an MEC reactor is of a cylindrical structure, and adopts the mode that five layers of biological anode plates 2 and five layers of biological cathode plates 3 are combined, the biological anode plates 2 and the biological cathode plates 3 are alternately arranged in sequence, the number of the anode area wires and the number of the cathode area wires are each four, the anode area wires and the cathode area wires are connected with the anode plates and the cathode plates respectively in a connection mode as shown in FIG. 3.

In the reactor, the ratio of the number of the biological anode plates 2 to the number of the biological cathode plates 3 is 1:1. In the embodiment, the ratio of a ring width of each hollow annular plate in the biological anode plates 2 and the biological cathode plates 3 to an outer diameter of the hollow annular plate is 0.3:1, a thickness of the hollow annular plate is 3 cm. The reactor can effectively carry out anaerobic digestion on organic wastes such as sewage, sludge and kitchen wastes, and can be produced on a large scale in practical application.

In the specific implementation process, the operation method of the reactor system includes the steps of electrode plate acclimation, arrangement of biological anode plates, biological cathode plates and wires, control of feeding and current of system, and anaerobic digestion. According to the technical scheme, the MEC reactor system is used for strengthening anaerobic digestion of sludge, and in a biological anode acclimation area, secondary sludge from the secondary sedimentation tank and an anode microorganism culture solution are used as substrates, the anode potential is 0.6 V, biofilm culturing and acclimation is carried out on the anode plates, with a acclimation time of 20 d, and after acclimation, the relative abundance of electrochemically active bacteria in anode biofilms reaches 50% or above. In a biological cathode acclimation area, bovine serum albumin, inoculated sludge and a cathode microorganism culture solution are used as substrates, the cathode potential is −0.4 V, biofilm culturing and acclimation is carried out on the cathode plates, with a acclimation time of 30 d, and after acclimation, the relative abundance of methane bacteria in cathode biofilms reaches 60% or above.

The biological anode plates 2 and the biological cathode plates 3 which have been subjected to biofilm culturing and acclimation, are laid in the anaerobic digestion reaction area according to the number ratio of 2:1, connected to the anode area wires and the cathode area wires respectively, and connected to the automatic control power supply which is in an off state. Then, waste activated sludge serving as a treatment object is fed into the anaerobic digestion reaction area in a semi-continuous mode, the temperature is set to 37° C., the stirring speed is set to 100 rpm, and the residence time is set to 20 d. After feeding the system, the automatic control power supply is turned on, the initial output voltage of the programmable direct-current power supply is 0.6 V, the current sensor monitors the current change of the system and feeds the current change back to the programmable direct-current power supply, and the voltage output by the direct-current power supply is set according to the input current, so that the micro-voltage of the MEC reaction system is intelligently and accurately optimized in real time, the current of the system is stably kept in a range of 5+/−2 mA, and intelligent and stable operation of the system is achieved.

According to the technical scheme, the MEC reactor system strengthens anaerobic digestion of the kitchen wastes, the solid content of the kitchen wastes is 21.08%, and the proportion of volatile solids in total solids is 91.02%. The biological anode plates and the biological cathode plates which have been subjected to biofilm culturing and acclimation are laid in the anaerobic digestion reaction area according to the number ratio of 1:4, connected to the anode area wires and the cathode area wires respectively, and connected to the automatic control power supply in a off state. Then, waste activated sludge serving as a treatment object is fed into the anaerobic digestion reaction area in batches, the temperature is set to 55° C., the stirring speed is 150 rpm, and the residence time is 30 d. After feeding the system, the automatic control power supply is turned on, the initial output voltage of the programmable direct-current power supply is 0.8 V, the current sensor monitors the current change of the system and feeds the current change back to the programmable direct-current power supply, the automatic control power supply enables the current of the system to be stably kept within the range of 10+/−2 mA for anaerobic digestion, and the methane production stagnation period, the methane yield and the proportion of methane in biogas in the process are monitored.

### Contrast Example I

A conventional MEC reactor, namely a single-chamber MEC reactor including a direct-current power supply, wires, anode plates and cathode plates is adopted, and the electrode material, the feeding substrates, the feeding mode, the anaerobic digestion temperature, the stirring speed and the anaerobic digestion time are same as those in embodiment 1. The anaerobic digestion is carried out at a direct-current voltage of 0.8 V, and the methane production stagnation period, the methane yield and the proportion of methane in biogas are monitored in the process.

Experimental results show that the methane production stagnation period in embodiment I is 0.4 d, which is shortened by 77.8% compared with 1.8 d in contrast example I; the methane yield is 550 mL/g VS, which is increased by 41.0% compared with 390 mL/g VS in contrast example I; and the proportion of methane in the biogas is 90.5%, which is increased by 20.3% compared with 75.2% in contrast example 1. These results fully illustrate the superior performance and technical effect of the MEC reactor system in the present technical scheme in strengthening anaerobic digestion, compared with the conventional MEC reactor.

The foregoing description of the embodiments is provided to facilitate those skilled in the art to understand and use the present disclosure. It will be apparent to those skilled in the art that various modifications to these embodiments can be readily made, and that the generic principles described herein can be applied to other embodiments without inventive faculty. Therefore, the present disclosure is not limited to the embodiments described above, and improvements and modifications made by those skilled in the art, without departing from the scope of the present disclosure, should be within the scope of the present disclosure.

What is claimed is:

1. An Microbial Electrolysis Cell (MEC) reactor system for strengthening anaerobic digestion, comprising
a reactor module, comprising a biological anode plate acclimation area, a biological cathode plate acclimation area and an anaerobic digestion reaction area;
a plurality of biological anode plates (2) and a plurality of biological cathode plates (3), which are arranged in the reactor module, and
an automatic control power supply (1), an anode of the automatic control power supply (1) being connected with anode area wires and a cathode thereof being connected with cathode area wires, the anode area wires are electrically connected with the biological anode plates (2), and the cathode area wires are electrically connected with the biological cathode plates (3);
wherein the biological anode plates and the biological cathode plates are subjected to biofilm culturing and acclimation in the biological anode plate acclimation area and the biological cathode plate acclimation area respectively; and
the biological anode plates and the biological cathode plates which have been subjected to the biofilm culturing and acclimation are placed in the anaerobic digestion reaction area, to strengthen the anaerobic digestion.

2. The MEC reactor system according to claim 1, wherein the automatic control power supply (1) comprises a current sensor and a programmable direct-current power supply, and the current sensor acquires an output current value of the programmable direct-current power supply in real time and feeds the current value back to the programmable direct-current power supply in real time.

3. The MEC reactor system according to claim 1, wherein a number of the biological anode plates (2) and a number of the biological cathode plates (3) are greater than or equal to two, and a ratio of the number of the biological anode plates (3) to the number of the biological cathode plates (3) is (0.2 to 5):1.

4. The MEC reactor system according to claim 1, wherein the biological anode plates (2) and the biological cathode plates (3) are hollow annular plates; and
a ratio of a ring width of each hollow annular plate to an outer diameter of the hollow annular plate is (0.1 to 0.6):1, and a thickness of the hollow annular plate is 1 to 10 cm.

5. The MEC reactor system according to claim 1, wherein when the biological anode plates (2) are subjected to the biofilm culturing and acclimation in the biological anode plate acclimation area, an anode potential is 0.1 to 1.0 V, and a first acclimation time is 10 to 30 d; and
the biological cathode plates (3) are subjected to the biofilm culturing and acclimation in the biological cathode plate acclimation area, a cathode potential is −0.1 to −0.8 V, and a second acclimation time is 15 to 40 d.

6. The MEC reactor system according to claim 1, wherein each anode area wire and each cathode area wire are respectively provided with a plurality of first branch wires and a plurality of second branch wires, which are anode area branch wires and cathode area branch wires respectively;
the biological anode plates (2) are connected with the anode area branch wires, each of the biological anode plates (2) is connected with a corresponding one of the anode area branch wires, or symmetrically connected with corresponding two of the anode area branch wires, or connected with corresponding four of the anode area branch wires which are distributed uniformly around the biological anode plates (2); and
the biological cathode plates (3) are connected with the cathode area branch wires, each of the biological cathode plates (3) is connected with corresponding one of the cathode area branch wires, or symmetrically connected with corresponding two of the cathode area branch wires, or connected with corresponding four of the cathode area branch wires which are distributed uniformly around the biological cathode plates (3).

7. The MEC reactor system according to claim 1, wherein in an operation process of the MEC reactor system, the biological anode plates (2) and the biological cathode plates (3) which have been subjected to the biofilm culturing and acclimation, are sequentially arranged in the anaerobic digestion reaction area in a vertical direction according to one of various ratios of the number of the biological anode plates to the number of the biological cathode plates, and are connected with the anode area wires and the cathode area wires respectively, and are connected with the automatic control power supply (1).

8. The MEC reactor system according to claim 1, wherein in an operation process of the MEC reactor system, after feeding the MEC reactor system, the automatic control power supply (1) is turned on, a current sensor monitors a change of a current of the MEC reactor system, and when the current of the MEC reactor system is stable and is in a range of 1 to 200 mA, the MEC reactor system is in a stable operation state.

9. The MEC reactor system according to claim 1, wherein the MEC reactor system is fed in one mode of batch feeding, semi-continuous feeding and continuous feeding.

10. The MEC reactor system according to claim 1, wherein a temperature of the anaerobic digestion reaction area is 25′C to 65° C., a stirring speed is 60 to 150 rpm, and a residence time is 5 to 30 d.
